(19) United States
(12) Patent Application Publication
(10) Pub. No.: US 2018/0046528 A1
(43) Pub. Date: Feb. 15, 2018

(54) HARD DISK DRIVE MANAGEMENT SYSTEM AND ELECTRONIC DEVICE USING THE SAME

(71) Applicant: HON HAI PRECISION INDUSTRY CO., LTD., New Taipei (TW)

(72) Inventor: WEI-SHUAI LIAO, New Taipei (TW)

(21) Appl. No.: 15/252,237

(22) Filed: Aug. 31, 2016

(30) Foreign Application Priority Data
Aug. 11, 2016 (CN) 201610655433.X

(51) Int. Cl. G06F 11/07; G11B 20/18

(52) U.S. Cl. CPC G06F 11/079; G11B 20/18; G06F 11/0727; G06F 11/0751; G06F 11/0772; G06F 11/0787

(57) ABSTRACT

A management system for a plurality of hard disk drives which gives disk-specific information includes a storage unit and a processor. The storage unit is configured to couple to the plurality of hard disk drives and includes an information module configured to store identification information of each hard disk drive and a checking module configured to check status of each hard disk drive according to a location information in the identification and send out an error warning if in error status. The processor is coupled to the storage unit and obtains the identification information and error warnings. The error warning comprises the identification information and an error type of the error hard disk drive. An electronic device with the management system is further provided.

### FIELD

The subject matter herein generally relates to a management system for a plurality of hard disk drives and an electronic device with the disk management system.

### BACKGROUND

A plurality of hard disk drives is generally used in an electronic device, such as a server, to expand storage space of the electronic device. It is difficult to determine when the plurality of hard disk drives is damaged or which one of the plurality of hard disk drives is damaged.

### BRIEF DESCRIPTION OF THE DRAWINGS

Implementations of the present technology will now be described, by way of example only, with reference to the attached figures.

FIG. 1 is a block diagram of one embodiment of an electronic device with a hard disk drive management system.

FIG. 2 is a block diagram of the hard disk drive management system of FIG. 1 and a plurality of hard disk drives.

FIG. 3 is a block diagram of a storage unit of the hard disk drive management system of FIG. 2.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series, and the like.

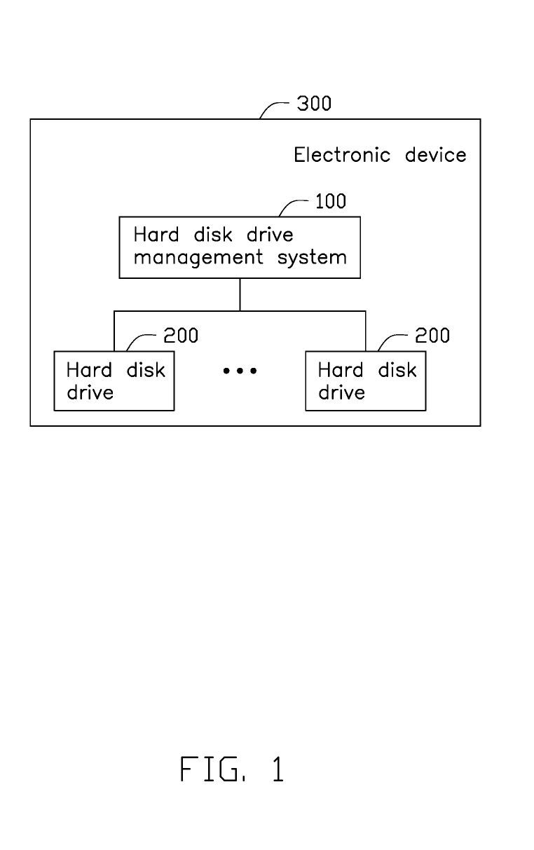

FIG. 1 illustrates an electronic device 300 in accordance with an embodiment. The electronic device 300 can include a hard disk drive management system 100 and a plurality of hard disk drives 200 each coupled to the management system 100. The management system 100 is configured to manage each hard disk drive in the plurality of hard disk drives 200.

In at least one embodiment, each hard disk drive 200 is an M.2 solid state disk (SSD).

In at least one embodiment, the management system 100 is a server or a computer.

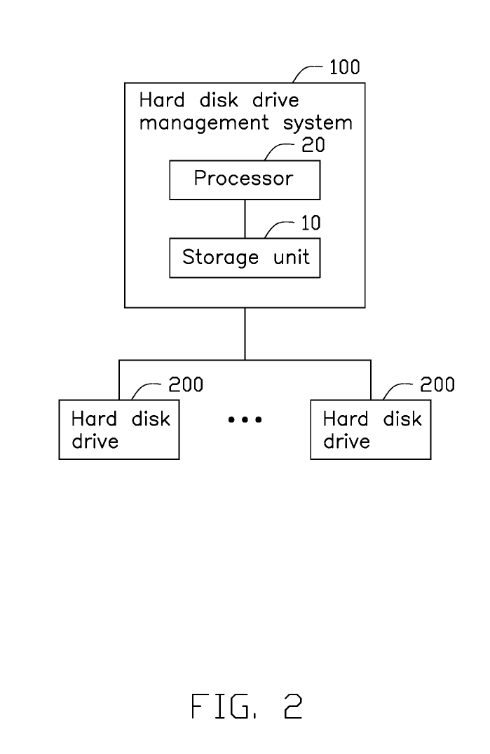

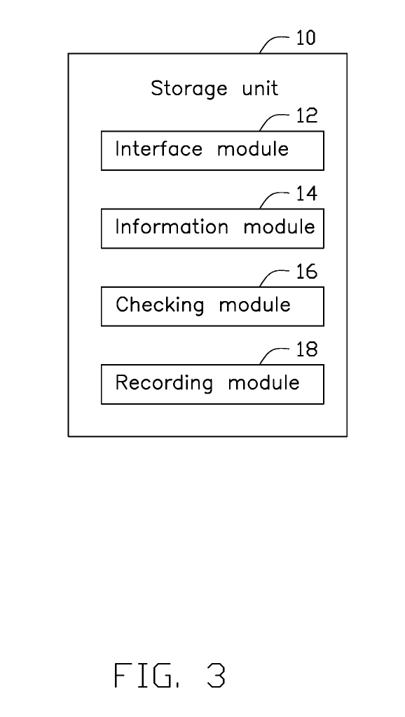

FIG. 2 and FIG. 3 illustrate that the management system 100 can include a storage unit 10 and a processor 20 coupled to the storage unit 10.

The storage unit 10 is configured to store program commands and data. In at least one embodiment, the storage unit 10 includes an interface module 12, an information module 14, a checking module 16, and a recording module 18.

The interface module 12 includes a plurality of interfaces (not shown) configured to couple to the plurality of hard disk drives 200.

In at least one embodiment, each interface is a peripheral component interconnect express (PCI-E) interface.

The information module 14 includes identification information of each hard disk drive 200. The identification information identifies a hard disk drive and includes type, series number, capacity, a location of each hard disk drive, and a connection status between each hard disk drive and an interface.

The information module 14 further stores the amount of the plurality of hard disk drives 200 and updates the amount of the plurality of hard disk drives 200 when the amount of the plurality of hard disk drives 200 is increased or decreased.

The checking module 16 is configured to check an operation status of each hard disk drive 200 according to the location information in the identification information and create an error warning when the operation status of the hard disk drive is in error.

In at least one embodiment, the error warning includes an error type and the location information of the hard disk drive 200 in error.

The checking module 16 is further configured to send the error warning to the recording module 18.

The recording module 18 is configured to receive and store the error warning output by the checking module 16.

The processor 20 is configured to obtain the identification information of each hard disk drive 200 by inquiring of the information module 14.

In at least one embodiment, the processor 20 is a central processing unit (CPU).

In other embodiment, the processor 20 is an application specific integrated circuit (ASIC).

In use, the processor 20 obtain the identification information of each hard disk drive 200 by inquiring of the information module 14, so that users can obtain the location information and the connection status of each hard disk drive 200. The checking module 16 checks whether each hard disk drive 200 is in an error status and outputs error warning to the recording module 18 if any hard disk drive 200 is in the error status. The recording module 18 records the error warning, so that users can get full information about each hard disk drive 200.

The embodiments shown and described above are only examples. Many details are often found in the art such as the other features of a management system and method. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A management system for a plurality of hard disk drives comprising:
a storage unit configured to couple to the plurality of hard disk drives and comprising:
an information module configured to store identification information of each hard disk drive; and
a checking module configured to check whether each hard disk drive is in an error status according to a location information in the identification information and send out an error warning when any hard disk drive is the error status;
a processor coupled to the storage unit and configured to obtain the identification information of each hard disk drive and the error warning;
wherein the error warning comprises the identification information and an error type of the hard disk drive, which is in the error status.

2. The management system of claim 1, wherein the storage unit further comprises a recording module configured to obtain the error warning and store the error warning.

3. The management system of claim 2, wherein the storage unit further comprises an interface module, the interface module comprises a plurality of coupling ports, and the storage module is coupled to the plurality of hard disk drives through the plurality of coupling ports.

4. The management system of claim 3, wherein the identification information comprises the location information of each hard disk drive and a connection status between each coupling port and a corresponding hard disk drive.

5. The management system of claim 4, wherein the identification information further comprises type information, series number, capacity information of each hard disk drive.

6. The management system of claim 3, wherein each coupling port is a peripheral component interconnect express interface.

7. The management system of claim 3, wherein the processor is a central processing unit.

8. The management system of claim 3, wherein the processor is an application specific integrated circuit.

9. An electronic device comprising:
a plurality of hard disk drives; and
a management system comprising:
a storage unit coupled to the plurality of hard disk drives and comprising:
an information module configured to store identification information of each hard disk drive; and
a checking module configured to check whether each hard disk drive is in an error status according to a location information in the identification information and send out an error warning when any hard disk drive is the error status; and
a processor coupled to the storage unit and configured to obtain the identification information of each hard disk drive and the error warning;
wherein the error warning comprises the identification information and an error type of the hard disk drive, which is in the error status.

10. The electronic device of claim 9, wherein the storage unit further comprises a recording module configured to obtain the error warning and store the error warning.

11. The electronic device of claim 10, wherein the storage unit further comprises an interface module, the interface module comprises a plurality of coupling ports, and the storage module is coupled to the plurality of hard disk drives through the plurality of coupling ports.

12. The electronic device of claim 11, wherein the identification information comprises the location information of each hard disk drive and a connection status between each coupling port and a corresponding hard disk drive.

13. The electronic device of claim 12, wherein the identification information further comprises type information, series number, capacity information of each hard disk drive.

14. The electronic device of claim 11, wherein each coupling port is a peripheral component interconnect express interface.

15. The electronic device of claim 11, wherein the processor is a central processing unit.

16. The electronic device of claim 11, wherein the processor is an application specific integrated circuit.
